(19) United States
(12) Patent Application Publication
(10) Pub. No.: US 2019/0114738 A1
(43) Pub. Date: Apr. 18, 2019

(54) IMAGE PROCESSING APPARATUS AND IMAGE PROCESSING METHOD

(71) Applicant: OLYMPUS CORPORATION, Tokyo (JP)

(72) Inventor: Yasuko SONODA, Tokyo (JP)

(73) Assignee: OLYMPUS CORPORATION, Tokyo (JP)

(21) Appl. No.: 16/213,246

(22) Filed: Dec. 7, 2018

Related U.S. Application Data
(63) Continuation of application No. PCT/JP2016/067924, filed on Jun. 16, 2016.

(51) Int. Cl. G06T 3/40

(52) U.S. Cl. CPC G06T 3/4023

(57) ABSTRACT

An image processing apparatus includes a processor. The processor is configured to: perform a process for detecting an area of interest for each of a plurality of observation images that are sequentially inputted; record the plurality of observation images as one or more recorded images during a period until detection of the area of interest is interrupted/ceased after the detection is started; and perform a process for, while causing the plurality of observation images to be sequentially displayed, causing at least one recorded image to be displayed at a first timing when a predetermined time period elapses after the detection of the area of interest is started or at a second timing when the detection of the area of interest is interrupted/ceased.

### CROSS REFERENCE TO RELATED APPLICATION

This application is a continuation application of PCT/JP2016/067924 filed on Jun. 16, 2016, the entire contents of which are incorporated herein by this reference.

### BACKGROUND OF THE INVENTION

### Field of the Invention

The present invention relates to an image processing apparatus and an image processing method.

### Description of the Related Art

In a medical field, a configuration is conventionally known in which, for example, images obtained by performing image pickup of an object are simultaneously displayed in one relatively large display area on a display screen of a display apparatus and in another relatively small area on the display screen.

More specifically, for example, Japanese Patent Application Laid-Open Publication No. H10-262923 discloses a configuration for causing images obtained by performing image pickup of an object by an electronic endoscope to be simultaneously displayed on a monitor as a parent screen and a child screen having mutually different sizes.

### SUMMARY OF THE INVENTION

An image processing apparatus of one aspect of the present invention includes a processor. The processor is configured to: perform a process for detecting an area of interest for each of a plurality of observation images that are sequentially inputted; record the plurality of observation images as one or more recorded images during a time period until detection of the area of interest is interrupted/ceased after the detection is started; and perform a process for, while causing the plurality of observation images to be sequentially displayed on a display screen of a display apparatus, causing at least one recorded image among the one or more recorded images to be displayed on the display screen at a first timing when a predetermined time period elapses after the detection of the area of interest is started or at a second timing when the detection of the area of interest is interrupted/ceased

An image processing method of one aspect of the present invention includes: performing a process for detecting an area of interest for each of a plurality of observation images obtained by performing image pickup of an object; recording the plurality of observation images as one or more recorded images during a time period until detection of the area of interest is interrupted/ceased after the detection is started; and performing a process for, while causing the plurality of observation images to be sequentially displayed on a display screen of a display apparatus, causing at least one recorded image among the one or more recorded images to be displayed on the display screen at a first timing when a predetermined time period elapses after the detection of the area of interest is started or at a second timing when the detection of the area of interest is interrupted/ceased.

### BRIEF DESCRIPTION OF THE DRAWINGS

FIG. 1 is a diagram showing a configuration of main parts of an endoscope system including an image processing apparatus according to an embodiment;

FIG. 2 is a block diagram for illustrating an example of a specific configuration of the image processing apparatus according to the embodiment;

FIG. 3 is a time chart for illustrating an example of a process performed in the image processing apparatus according to the embodiment;

FIG. 4 is a diagram showing an example of a display image displayed on a display apparatus after a process of the image processing apparatus according to the embodiment is performed;

FIG. 5 is a diagram showing an example of a display image displayed on the display apparatus after a process of the image processing apparatus according to the embodiment is performed;

FIG. 6 is a diagram showing an example of a display image displayed on the display apparatus after a process of the image processing apparatus according to the embodiment is performed;

FIG. 7 is a diagram showing an example of a display image displayed on the display apparatus after a process of the image processing apparatus according to the embodiment is performed;

FIG. 8 is a time chart for illustrating an example of a process performed in the image processing apparatus according to the embodiment, which is different from the example of FIG. 3;

FIG. 9 is a diagram showing an example of a display image displayed on the display apparatus after a process of the image processing apparatus according to the embodiment is performed;

FIG. 10 is a diagram showing an example of a display image displayed on the display apparatus after a process of the image processing apparatus according to the embodiment is performed;

FIG. 11 is a diagram showing an example of a display image displayed on the display apparatus after a process of the image processing apparatus according to the embodiment is performed;

FIG. 12 is a diagram showing an example of a display image displayed on the display apparatus after a process of the image processing apparatus according to the embodiment is performed;

FIG. 13 is a diagram showing an example of a display image displayed on the display apparatus after a process of the image processing apparatus according to the embodiment is performed;

FIG. 14 is a diagram showing an example of a display image displayed on the display apparatus after a process of the image processing apparatus according to the embodiment is performed;

FIG. 15 is a diagram showing an example of a display image displayed on the display apparatus after a process of the image processing apparatus according to the embodiment is performed; and

FIG. 16 is a diagram showing an example of a display image displayed on the display apparatus after a process of the image processing apparatus according to the embodiment is performed.

### DETAILED DESCRIPTION OF THE PREFERRED EMBODIMENT

An embodiment of the present invention will be described below with reference to drawings.

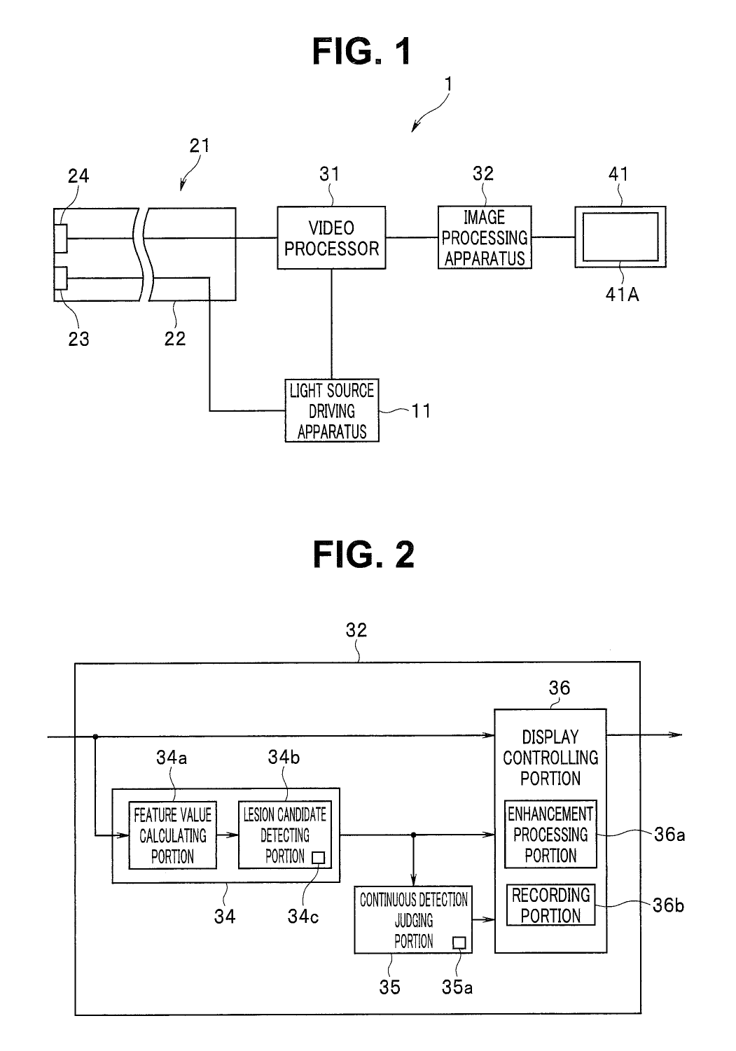

As shown in FIG. 1, an endoscope system 1 is configured including a light source driving apparatus 11, an endoscope 21, a video processor 31, an image processing apparatus 32 and a display apparatus 41.

The light source driving apparatus 11 is configured, for example, being provided with a drive circuit. The light source driving apparatus 11 is connected to the endoscope 21 and the video processor 31. The light source driving apparatus 11 is configured to generate a light source driving signal for driving a light source portion 23 of the endoscope 21 based on a light source control signal from the video processor 31 and output the generated light source driving signal to the endoscope 21.

The endoscope 21 is connected to the light source driving apparatus 11 and the video processor 31. The endoscope 21 is configured including an elongated-shaped insertion portion 22 insertable into a body cavity of an examinee A distal end portion of the insertion portion 22 is provided with the light source portion 23 and an image pickup portion 24.

The light source portion 23 is configured being provided with a light emitting device such as a white LED. The light source portion 23 is configured to generate illuminating light by emitting light in response to a light source driving signal outputted from the light source driving apparatus 11 and radiate the generated illuminating light to an object such as a body tissue.

The image pickup portion 24 is configured including an image sensor, for example, a color CCD or a color CMOS. The image pickup portion 24 is configured to perform an operation corresponding to an image pickup control signal outputted from the video processor 31. The image pickup portion 24 is configured to receive reflected light from an object illuminated by illuminating light from the light source portion 23, pick up an image of the received reflected light to generate an image pickup signal, and output the generated image pickup signal to the video processor 31.

The video processor 31 is connected to the light source driving apparatus 11 and the endoscope 21. The video processor 31 is configured to generate a light source control signal for controlling a light emission state of the light source portion 23 and output the light source control signal to the light source driving apparatus 11. The video processor 31 is configured to generate and output an image pickup control signal for controlling an image pickup operation of the image pickup portion 24. The video processor 31 is configured to generate an observation image G1 of an object by performing predetermined processing of an image pickup signal outputted from the endoscope 21 and sequentially output the generated observation image G1 to the image processing apparatus 32 frame by frame.

The image processing apparatus 32 is configured being provided with an electronic circuit such as an image processing circuit. The image processing apparatus 32 is configured to perform an operation for generating a display image based on an observation image G1 outputted from the video processor 31 and causing the generated display image to be displayed on the display apparatus 41. As shown in FIG. 2, the image processing apparatus 32 is configured including an area-of-interest detecting portion 34, a continuous detection judging portion 35 and a display controlling portion 36. FIG. 2 is a block diagram for illustrating an example of a specific configuration of the image processing apparatus according to the embodiment.

The area-of-interest detecting portion 34 is configured to calculate predetermined feature values for each observation image G1 sequentially outputted from the video processor 31 and further detect a lesion candidate area L, which is an area of interest included in the observation image G1, based on the calculated predetermined feature values. That is, the area-of-interest detecting portion 34 is configured such that a plurality of observation images G1 obtained by performing image pickup of an object by the endoscope 21 are sequentially inputted and is configured to detect a process for detecting the lesion candidate area L for each of the plurality of observation images G1. The area-of-interest detecting portion 34 is configured including a feature value calculating portion 34a and a lesion candidate detecting portion 34b.

The feature value calculating portion 34a is connected to the video processor 31 and the lesion candidate detecting portion 34b. The feature value calculating portion 34a is configured to calculate the predetermined feature values for each observation image G1 sequentially outputted from the video processor 31 and output the calculated predetermined feature values to the lesion candidate detecting portion 34b.

More specifically, the feature value calculating portion 34a calculates, for each of a plurality of small areas obtained by dividing an observation image G1 in a predetermined size, an inclination value, which is a value indicating an amount of change in brightness or density between each pixel in the small area and each pixel in a small area next to the small area, as a feature value. Note that the feature value calculating portion 34a may calculate a value different from the inclination value described above as a feature value as long as the feature value calculating portion 34a calculates a value capable of quantitatively evaluating an observation image G1.

The lesion candidate detecting portion 34b is connected to the continuous detection judging portion 35 and the display controlling portion 36. The lesion candidate detecting portion 34b is configured including a ROM 34c in which one or more pieces of polyp model information are stored in advance.

More specifically, the polyp model information stored in the ROM 34c is configured, for example, being provided with feature values obtained by quantifying common points and/or similarities in a lot of polyp images.

The lesion candidate detecting portion 34b is configured to detect a lesion candidate area L based on the predetermined feature values outputted from the feature value calculating portion 34a and the plurality of pieces of polyp model information read from the ROM 34c, acquire lesion candidate information IL, which is information showing the detected lesion candidate area L, and output the acquired lesion candidate information IL to each of the continuous detection judging portion 35 and the display controlling portion 36.

More specifically, for example, if a feature value of one small area outputted from the feature value calculating portion 34a corresponds to at least one feature value included in the plurality of pieces of polyp model information read from the ROM 34c, the lesion candidate detecting portion 34b detects the one small area as a lesion candidate area L. The lesion candidate detecting portion 34b acquires lesion candidate information IL that includes position information and size information about a lesion candidate area L detected by the method described above, and outputs the acquired lesion candidate information IL to each of the continuous detection judging portion 35 and the display controlling portion 36.

Note that the position information about a lesion candidate area L is information showing a position of the lesion candidate area L in an observation image G1 and is acquired, for example, as a pixel position of the lesion candidate area L existing in the observation image G1. The size information about the lesion candidate area L is information showing a size of the lesion candidate area L in the observation image G1 and is acquired, for example, as the number of pixels of the lesion candidate area L existing in the observation image G1.

Note that the area-of-interest detecting portion 34 may not be configured including the feature value calculating portion 34a or the lesion candidate detecting portion 34b as long as the area-of-interest detecting portion 34 performs the process for detecting a lesion candidate area L from an observation image G1. More specifically, the area-of-interest detecting portion 34 may be configured to detect a lesion candidate area L from an observation image G1, for example, by performing a process of applying an image identifier, which has acquired a function of being capable of distinguishing a polyp image by a learning method such as deep learning, to the observation image G1.

The continuous detection judging portion 35 is connected to the display controlling portion 36. The continuous detection judging portion 35 is configured including a RAM 35a capable of storing at least lesion candidate information IL one frame before, among respective pieces of lesion candidate information IL outputted from the lesion candidate detecting portion 34b.

The continuous detection judging portion 35 is configured to, for example, based on first lesion candidate information outputted from the lesion candidate detecting portion 34b and second lesion candidate information stored in the RAM 35a one frame before the first lesion candidate, determine whether a first lesion candidate area shown by the first lesion candidate information and a second lesion candidate area shown by the second lesion candidate information are the same lesion candidate area L or not. The continuous detection judging portion 35 is configured to, if the first and second lesion candidate areas described above are the same lesion candidate area L, acquire a judgment result that detection of a lesion candidate area L in an observation image G1 continues, that is, a judgment result that a lesion candidate area L detected by the lesion candidate detecting portion 34b continues to exist in an observation image G1 and output the judgment result to the display controlling portion 36. The continuous detection judging portion 35 is configured to, if the first and second lesion candidate areas described above are not the same lesion candidate area L, acquire a judgment result that detection of a lesion candidate area L in an observation image G1 has been interrupted/ceased, that is, a judgment result that a lesion candidate area L detected by the lesion candidate detecting portion 34b has moved outside from an inside of an observation image G1 and output the judgment result to the display controlling portion 36.

The display controlling portion 36 is connected to the display apparatus 41. The display controlling portion 36 is configured to, when lesion candidate information IL is inputted from the lesion candidate detecting portion 34b, measure a continuous detection time period TL, which is a time period elapsed after detection of a lesion candidate area L in an observation images G1 is started, based on a judgment result outputted from the continuous detection judging portion 35. The display controlling portion 36 is configured to perform a process for generating a display image using observation images G1 sequentially outputted from the video processor 31 and perform a process for causing the generated display image to be displayed on a display screen 41A of the display apparatus 41.

The display controlling portion 36 is configured to, based on a judgment result outputted from the continuous detection judging portion 35, perform a process described later if detection of a lesion candidate area L has been interrupted/ceased before the continuous detection time period TL reaches a predetermined time period TH (for example, 0.5 seconds). The display controlling portion 36 is configured to, based on a judgment result outputted from the continuous detection judging portion 35, perform an enhancement process described later if detection of a lesion candidate area L continues at a timing when the continuous detection time period TL reaches the predetermined time period TH. The display controlling portion 36 is configured including an enhancement processing portion 36a and a recording portion 36b.

The enhancement processing portion 36a is configured to, if detection of a lesion candidate area L continues at the timing when the continuous detection time period TL reaches the predetermined time period TH, generate a marker image G2 for enhancing a position of the lesion candidate area L based on lesion candidate information IL outputted from the lesion candidate detecting portion 34b and start an enhancement process of adding the marker image G2 to the observation image G1.

Note that the marker image G2 added by the enhancement process of the enhancement processing portion 36a may be in any form as long as the marker image G2 is capable of presenting a position of a lesion candidate area L as visual information. In other words, the enhancement processing portion 36a may perform the enhancement process using only position information included in lesion candidate information IL or may perform the enhancement process using both of position information and size information included in lesion candidate information IL as long as the enhancement processing portion 36a generates a marker image G2 for enhancing a position of a lesion candidate area L.

The recording portion 36b is configured to record observation images G1 sequentially outputted from the video processor 31 during a period of measurement of the continuous detection time period TL, as recorded images R1. That is, the recording portion 36b is configured to sequentially (in time-series order) record a plurality of observation images G1 sequentially outputted from the video processor 31 during a period until detection of a lesion candidate area L by the lesion candidate detecting portion 34b of the area-of-interest detecting portion 34 is interrupted/ceased after the detection is started, as a plurality of recorded images R1. The recording portion 36b is configured to be capable of mutually associating and recording pieces of lesion candidate information IL outputted from the lesion candidate detecting portion 34b during the period of measurement of the continuous detection time period TL and recorded images R1.

The display apparatus 41 is provided with a monitor and the like and is configured to be capable of displaying a display image outputted from the image processing apparatus 32.

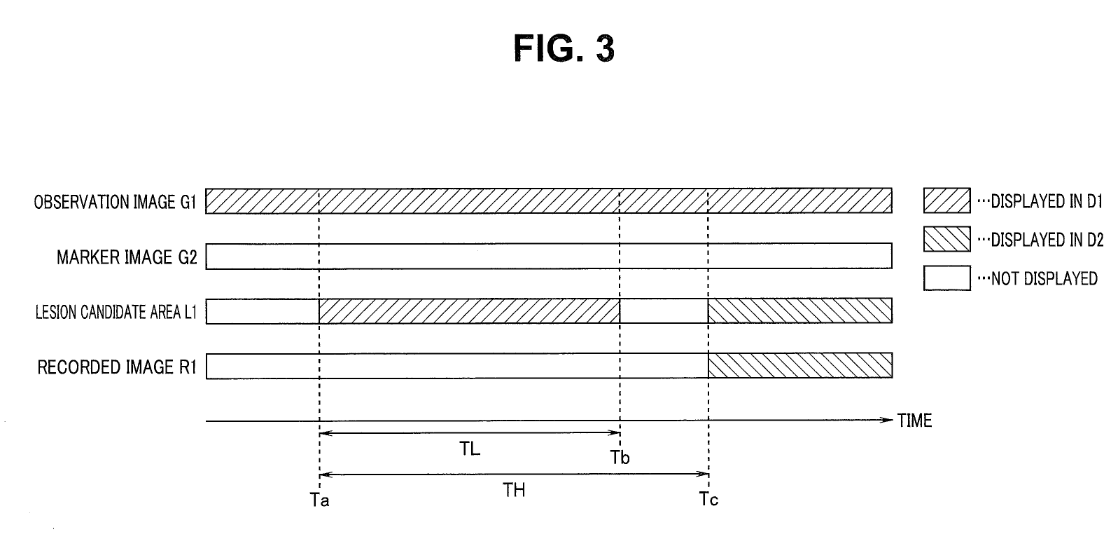

Next, operation of the present embodiment will be described. Note that, in the description below, a case where the lesion candidate detecting portion 34b detects one lesion candidate area L1 will be described as an example for simplification. In the description below, a case where the continuous detection time period TL of the lesion candidate area L1 is shorter than the predetermined time period TH, that is, a case where a process corresponding to a time chart of FIG. 3 is performed by the display controlling portion 36 will be described as an example. FIG. 3 is a time chart for illustrating an example of a process performed in the image processing apparatus according to the embodiment.

For example, when the light source driving apparatus 11 and the video processor 31 are powered on, the endoscope 21 radiates illuminating light to an object, receives reflected light from the object, picks up an image of the received reflected light to generate an image pickup signal, and outputs the generated image pickup signal to the video processor 31.

The video processor 31 generates an observation image G1 of an object by performing predetermined processing of an image pickup signal outputted from the endoscope 21 and sequentially outputs the generated observation image G1 to the image processing apparatus 32 frame by frame.

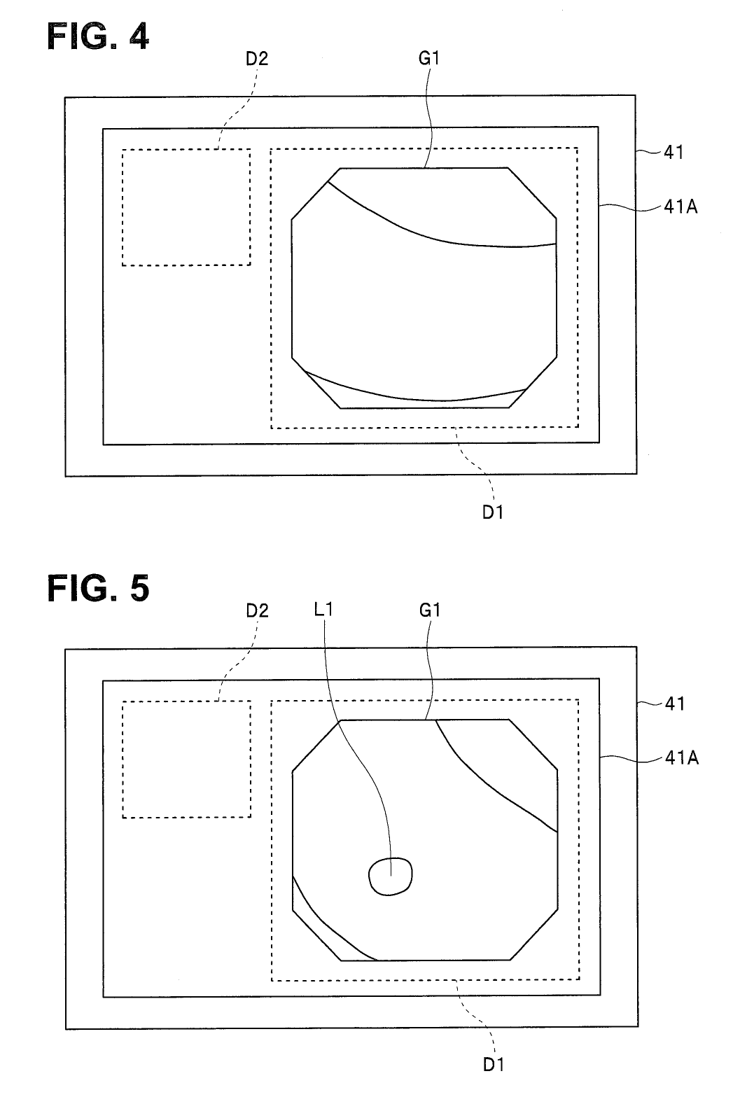

During a period while the lesion candidate area L1 is not detected by the area-of-interest detecting portion 34, the display controlling portion 36 performs a process for causing a display image on which an observation image G1 is disposed in a display area D1 on the display screen 41A to be displayed. According to such an operation of the display controlling portion 36, a display image as shown in FIG. 4 is displayed on the display screen 41A of the display apparatus 41, for example, during a period before time Ta in FIG. 3. Note that it is assumed that the display area D1 is set in advance, for example, as an area having a larger size than a display area D2 to be described later on the display screen 41A. FIG. 4 is a diagram showing an example of a display image displayed on the display apparatus after a process of the image processing apparatus according to the embodiment is performed.

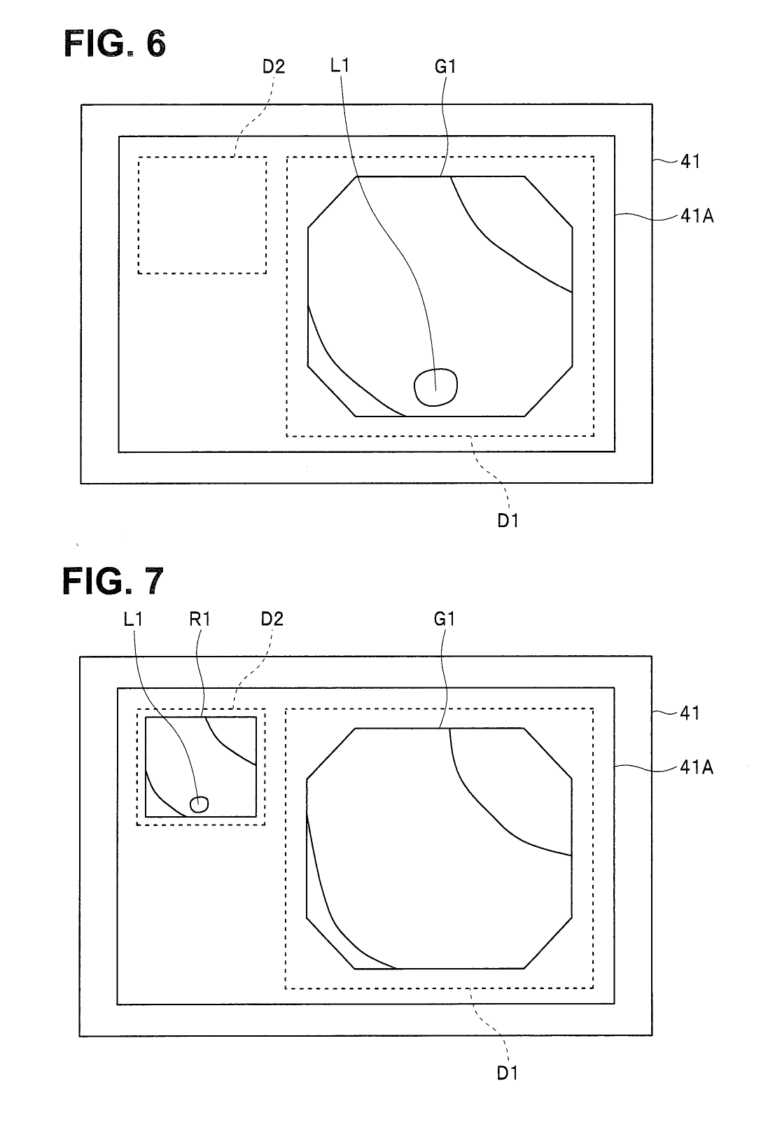

The display controlling portion 36 performs a process for causing a display image on which an observation image G1 including the lesion candidate area L1 is disposed in the display area D1 on the display screen 41A to be displayed, at a timing when measurement of the continuous detection time period TL is started, that is, at a timing when detection of the lesion candidate area L1 by the lesion candidate detecting portion 34b is started. According to such an operation of the display controlling portion 36, for example, a display image as shown in FIG. 5 is displayed on the display screen 41A of the display apparatus 41 at a timing of the time Ta in FIG. 3. According to the operation of the display controlling portion 36 as described above, for example, a display image as shown in FIG. 6 is displayed on the display screen 41A of the display apparatus 41 at a timing immediately before time Tb after the time Ta in FIG. 3 is reached. FIGS. 5 and 6 are diagrams showing examples of a display image displayed on the display apparatus after a process of the image processing apparatus according to the embodiment is performed.

The recording portion 36b of the display controlling portion 36 starts a process for recording observation images G1 sequentially outputted from the video processor 31 as recorded images R1 at the timing when measurement of the continuous detection time period TL is started, as recorded images R1 and starts a process for mutually associating and recording the recorded images R1 and pieces of lesion candidate information IL outputted from the lesion candidate detecting portion 34b. According to such an operation of the recording portion 36b, the process for mutually associating and recording the recorded images R1 and the pieces of lesion candidate information IL is started at the timing of the time Ta in FIG. 3.

The recording portion 36b of the display controlling portion 36 stops the process for recording observation images G1 sequentially outputted from the video processor 31 as recorded images R1, at a timing when measurement of the continuous detection time period TL is stopped, that is, at a timing when detection of the lesion candidate area L1 by the lesion candidate detecting portion 34b is interrupted/ceased, and stops the process for mutually associating and recording the recorded images R1 and pieces of lesion candidate information IL outputted from the lesion candidate detecting portion 34b. According to such an operation of the recording portion 36b, the process for mutually associating and recording the recorded images R1 and the pieces of lesion candidate information IL is stopped at the timing of the time Tb in FIG. 3. According to the operation of the recording portion 36b as described above, for example, during the continuous detection time period TL which corresponds to a period from the time Ta to the time Tb in FIG. 3, observation images G1 of N (N≥2) frames, including at least the observation images G1 as shown in FIGS. 5 and 6, are sequentially recorded as recorded images R1.

If detection of the lesion candidate area L1 is interrupted/ceased before the continuous detection time period TL reaches the predetermined time period TH, based on a judgment result outputted from the continuous detection judging portion 35, the display controlling portion 36 starts a process for displaying a display image on which an observation image G1 is disposed in the display area D1 on the display screen 41A, and recorded images R1 recorded by the recording portion 36b during the period of measurement of the continuous detection time period TL are sequentially disposed in the display area D2 on the display screen 41A, at a timing when the predetermined time period TH elapses after detection of the lesion candidate area L1 by the lesion candidate detecting portion 34b is started. According to such an operation of the display controlling portion 36, for example, a display image on which a recorded image R1 corresponding to an observation image G1 in FIG. 6 is disposed in the display area D2 as shown in FIG. 7 is displayed on the display screen 41A of the display apparatus 41 at a timing of time Tc after the time Tb in FIG. 3, which corresponds to a timing when the predetermine time period TH elapses after detection of the lesion candidate area L1 by the lesion candidate detecting portion 34b is started. Note that it is assumed that the display area D2 is set in advance, for example, as an area having a smaller size than the display area D1 described above on the display screen 41A. FIG. 7 is a diagram showing an example of a display image displayed on the display apparatus after a process of the image processing apparatus according to the embodiment is performed.

After the timing when the predetermined time period TH elapses after detection of the lesion candidate area L1 by the lesion candidate detecting portion 34b is started, the display controlling portion 36 performs a process for causing recorded images R1 to be sequentially displayed in order opposite to order of recording of the recorded images R1 by recording portion 36b. According to such an operation of the display controlling portion 36, for example, recorded images R1 of N frames sequentially recorded by the recording portion 36b are displayed in the display area D2 in order of N-th frame→(N−1)-th frame→ . . . →second frame→first frame.

That is, according to the operation of the display controlling portion 36 as described above, if the continuous detection time period TL is shorter than the predetermined time period TH, a process for, while causing a plurality of observation images G1 sequentially outputted from the video processor 31 to be sequentially displayed in the display area D1 on the display screen 41A, causing a plurality of recorded images R1 recorded during the period of measurement of the continuous detection time period TL to be displayed in the display area D2 on the display screen 41A in order opposite to order of recording by the recording portion 36b at a timing of the time Tc in FIG. 3 is started.

Here, for example, as shown in FIG. 3, if the continuous detection time period TL is shorter than the predetermined time period TH, a situation may occur in which, although the lesion candidate area L1 is detected by the lesion candidate detecting portion 34b, the lesion candidate area L1 moves outside from an inside of an observation image G1 without a marker image G2 being displayed. Therefore, it is conceivable that, if the continuous detection time period TL is shorter than the predetermined time period TH, oversight of the lesion candidate area L1 by a user's visual examination easily occurs.

In comparison, according to the operation of the display controlling portion 36 as described above, it is possible to, for example, as shown in FIGS. 3 and 7, cause a recorded image R1 including the lesion candidate area L1 already detected by the lesion candidate detecting portion 34b to be displayed in the display area D2 on the display screen 41A when the predetermined time period TH elapses after detection of the lesion candidate area L1 is started. Therefore, according to the operation of the display controlling portion 36 as described above, it is possible to reduce oversight of a lesion that may occur in endoscopic observation. According to the operation of the display controlling portion 36 as described above, since recorded images R1 are displayed in the display area D2 in order opposite to order of recording by the recording portion 36b, it is possible to inform the user, for example, of a position of the lesion candidate area L1 that has moved outside from an inside of an observation image G1 without a marker image G2 being given.

Note that, according to the present embodiment, it is possible to enable recording of recorded images R1 to be also continued, for example, during a period from the time Tb to the time Tc in FIG. 3 as long as recording of recorded images R1 is performed during the period of measurement of the continuous detection time period TL.

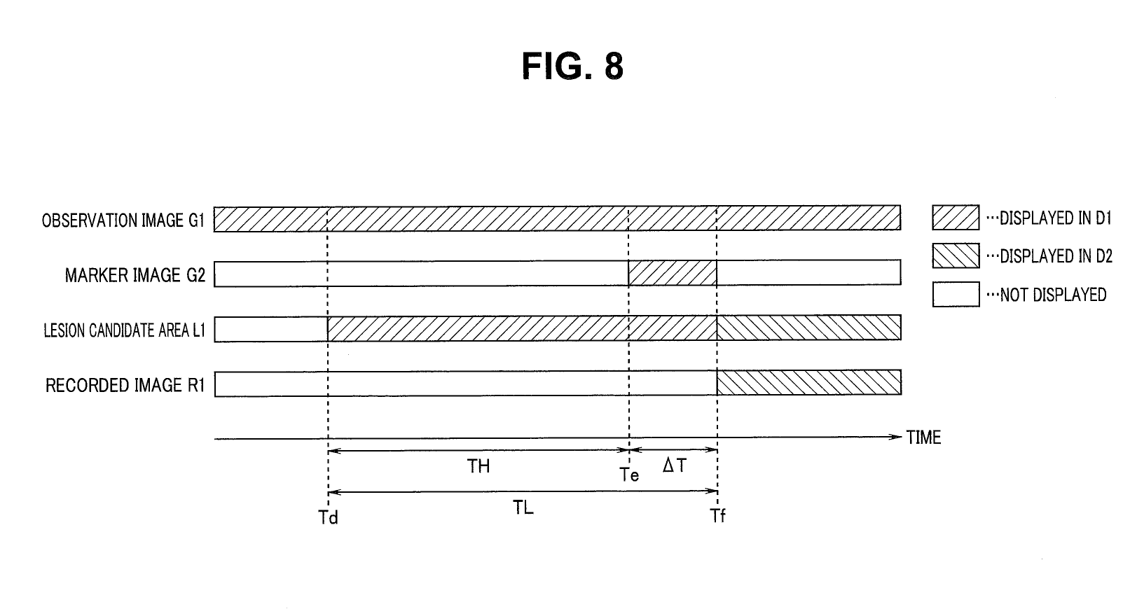

According to the present embodiment, for example, if the continuous detection time period TL of the lesion candidate area L1 is equal to or longer than the predetermined time period TH, the process corresponding to the time chart of FIG. 8 may be performed by the display controlling portion 36. Details of such a process will be described below. FIG. 8 is a time chart for illustrating an example of a process performed in the image processing apparatus according to the embodiment, which is different from the example of FIG. 3. Note that, hereinafter, specific description of parts to which the processes and the like already described are applicable will be appropriately omitted for simplification.

During a period while the lesion candidate area L1 is not detected by the area-of-interest detecting portion 34, the display controlling portion 36 performs a process for causing a display image on which an observation image G1 is disposed in a display area D1 on the display screen 41A to be displayed. According to such an operation of the display controlling portion 36, the display image as shown in FIG. 4 is displayed on the display screen 41A of the display apparatus 41, for example, during a period before time Td in FIG. 8.

The display controlling portion 36 performs the process for causing a display image on which an observation image G1 including the lesion candidate area L1 is disposed in the display area D1 on the display screen 41A to be displayed, at the timing when measurement of the continuous detection time period TL is started, that is, at the timing when detection of the lesion candidate area L1 by the lesion candidate detecting portion 34b is started. According to such an operation of the display controlling portion 36, for example, the display image as shown in FIG. 5 is displayed on the display screen 41A of the display apparatus 41 at a timing of the time Td in FIG. 8.

The recording portion 36b of the display controlling portion 36 starts the process for recording observation images G1 sequentially outputted from the video processor 31 as recorded images R1 at the timing when measurement of the continuous detection time period TL is started, as recorded images R1 and starts the process for mutually associating and recording the recorded images R1 and pieces of lesion candidate information IL outputted from the lesion candidate detecting portion 34b. According to such an operation of the recording portion 36b, the process for mutually associating and recording the recorded images R1 and the pieces of lesion candidate information IL is started at the timing of the time Td in FIG. 8.

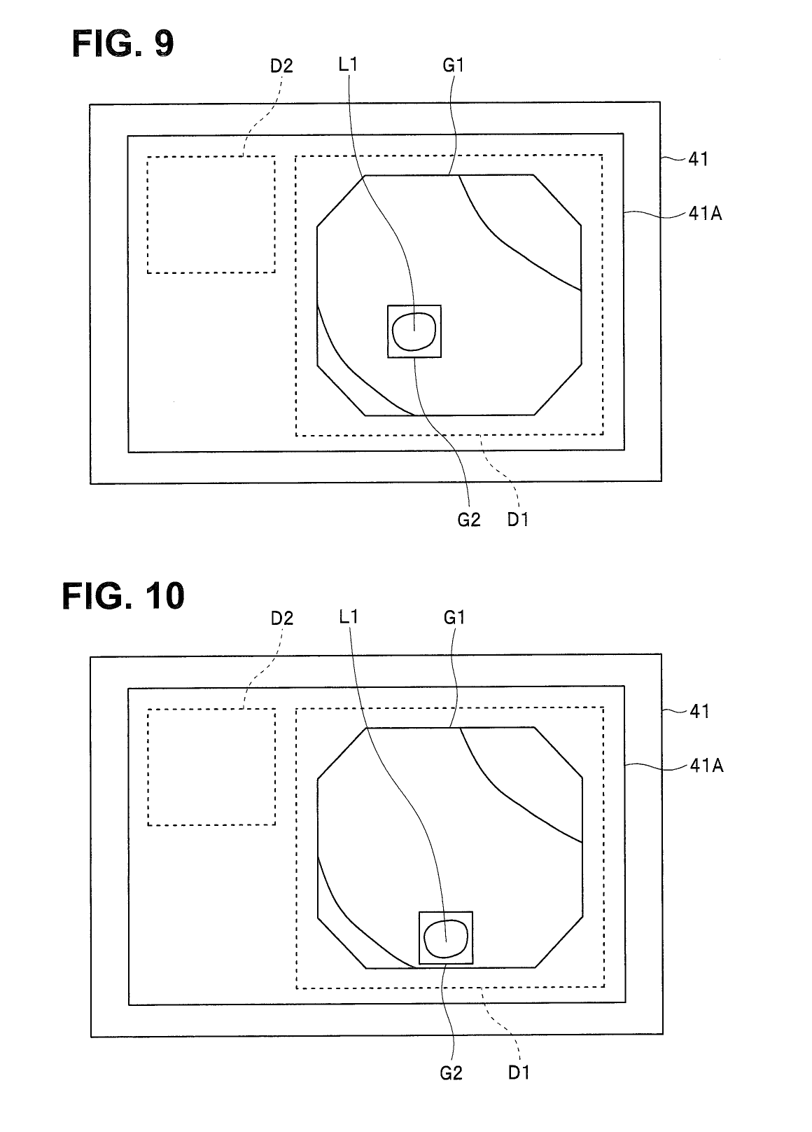

Based on a judgment result outputted from the continuous detection judging portion 35, the enhancement processing portion 36a of the display controlling portion 36 starts an enhancement process of adding a marker image G2 for enhancing a position of the lesion candidate area L1 detected by the lesion candidate detecting portion 34b to an observation image G1 at a timing when the predetermined time period TH elapses after measurement of the continuous detection time period TL is started. According to such an operation of the enhancement processing portion 36a, for example, a display image as shown in FIG. 9 is displayed on the display screen 41A of the display apparatus 41 at a timing of time Te in FIG. 8, which corresponds to the timing when the predetermined time period TH elapses after detection of the lesion candidate area L1 by the lesion candidate detecting portion 34b is started. According to the operation of the enhancement processing portion 36a as described above, a display image as shown in FIG. 10 is displayed on the display screen 41A of the display apparatus 41 at a timing immediately before time Tf after the time Te in FIG. 8 is reached. Note that, hereinafter, description will be advanced, with a case where a rectangular frame surrounding the lesion candidate area L1 as shown in FIGS. 9 and 10 is added as a marker image G2 by the enhancement process of the enhancement processing portion 36a given as an example. FIGS. 9 and 10 are diagrams showing examples of a display image displayed on the display apparatus after a process of the image processing apparatus according to the embodiment is performed.

The recording portion 36b of the display controlling portion 36 stops the process for recording observation images G1 sequentially outputted from the video processor 31 as recorded images R1, at the timing when measurement of the continuous detection time period TL is stopped, that is, at the timing when detection of the lesion candidate area L1 by the lesion candidate detecting portion 34b is interrupted/ceased, and stops the process for mutually associating and recording the recorded images R1 and pieces of lesion candidate information IL outputted from the lesion candidate detecting portion 34b. According to such an operation of the recording portion 36b, the process for mutually associating and recording the recorded images R1 and the pieces of lesion candidate information IL is stopped at a timing of the time Tf in FIG. 8. According to the operation of the recording portion 36b as described above, for example, during the continuous detection time period TL which corresponds to a period from the time Td to the time Tf in FIG. 8, observation images G1 of P (P≥2) frames, including at least observation images G1 as shown in FIGS. 9 and 10, are sequentially recorded as recorded images R1.

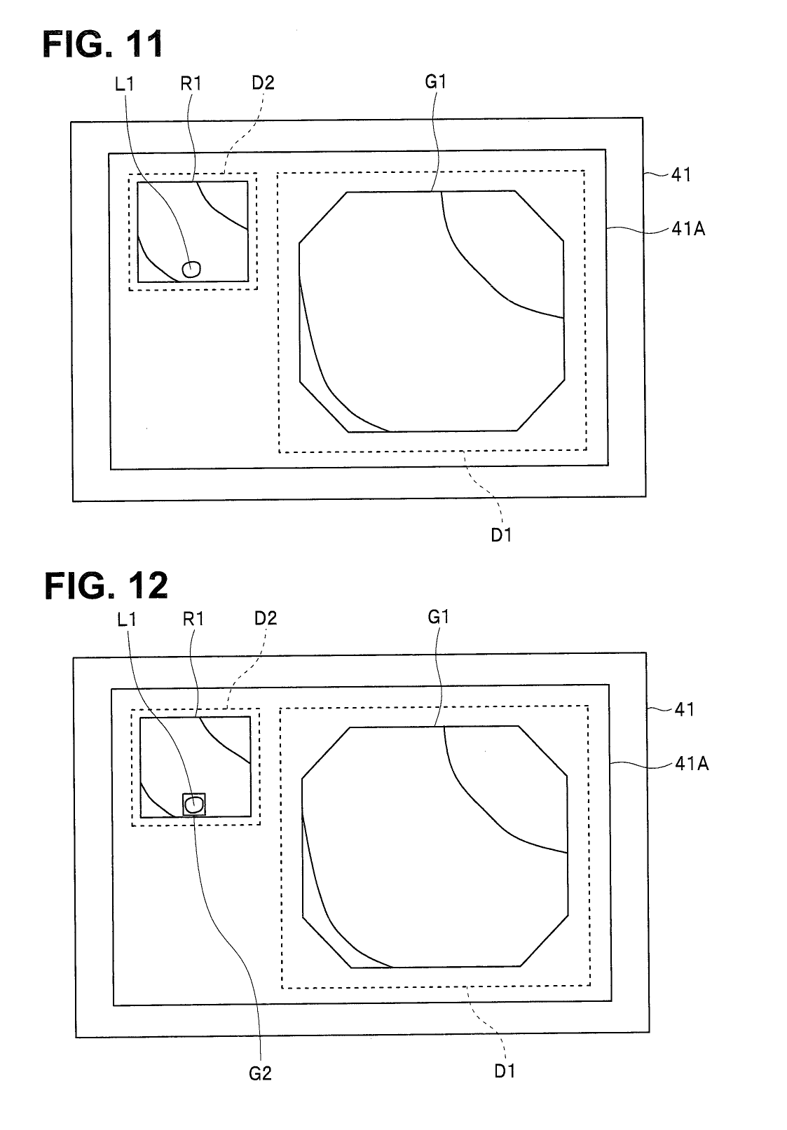

If detection of the lesion candidate area L1 is interrupted/ceased after the continuous detection time period TL becomes equal to or longer than the predetermined time period TH, based on a judgment result outputted from the continuous detection judging portion 35, the display controlling portion 36 starts the process for displaying a display image on which an observation image G1 is disposed in the display area D1 on the display screen 41A, and recorded images R1 recorded by the recording portion 36b during the period of measurement of the continuous detection time period TL are sequentially disposed in the display area D2 on the display screen 41A, at the timing when detection of the lesion candidate area L1 is interrupted/ceased. According to such an operation of the display controlling portion 36, for example, a display image on which a recorded image R1 corresponding to the observation image G1 in FIG. 10 is displayed in the display area D2, as shown in FIG. 11, is displayed on the display screen 41A of the display apparatus 41 at the timing of the time Tf in FIG. 8. FIG. 11 is a diagram showing an example of a display image displayed on the display apparatus after a process of the image processing apparatus according to the embodiment is performed.

After the timing when detection of the lesion candidate area L1 by the lesion candidate detecting portion 34b is interrupted/ceased, the display controlling portion 36 performs the process for causing recorded images R1 to be sequentially displayed in order opposite to order of recording of the recorded images R1 by the recording portion 36b. According to such an operation of the display controlling portion 36, for example, recorded images R1 of P frames sequentially recorded by the recording portion 36b are displayed in the display area D2 in order of P-th frame→(P−1)-th frame→ . . . →second frame→first frame.

That is, according to the operation of the display controlling portion 36 as described above, if the continuous detection time period TL is equal or longer than the predetermined time period TH, the process for, while causing a plurality of observation images G1 sequentially outputted from the video processor 31 to be sequentially displayed in the display area D1 on the display screen 41A, causing a plurality of recorded images R1 recorded during the period of measurement of the continuous detection time period TL to be displayed in the display area D2 on the display screen 41A in order opposite to order of recording by the recording portion 36b at the timing of the time Tf in FIG. 8 is started.

Here, for example, if a difference time period ΔT between the continuous detection time period TL and the predetermined time period TH, which corresponds to a period from the time Te to the time Tf in FIG. 8, is extremely short, a situation may occur in which, without the user visually confirming a marker image G2 instantaneously displayed in the display area D1, the lesion candidate area L1 enhanced by the marker image G2 moves outside from an inside of an observation image G1. Therefore, it is also conceivable that, if the difference time period ΔT is extremely short, oversight of the lesion candidate area L1 by the user's visual examination easily occurs.

In comparison, according to the operation of the display controlling portion 36 as described above, it is possible to, for example, as shown in FIGS. 8 and 11, cause a recorded image R1 including the lesion candidate area L1 already detected by the lesion candidate detecting portion 34b to be displayed in the display area D2 on the display screen 41A when detection of the lesion candidate area L1 is interrupted/ceased after the predetermined time TH elapses. Therefore, according to the operation of the display controlling portion 36 as described above, it is possible to reduce oversight of a lesion that may occur in endoscopic observation. According to the operation of the display controlling portion 36 as described above, since recorded images R1 are displayed in the display area D2 in order opposite to order of recording by the recording portion 36b, it is possible to inform the user, for example, of a position of the lesion candidate area L1 that has moved outside from an inside of an observation image G1 after a marker image G2 is instantaneously given.

Note that the operation of the display controlling portion 36 as described above is also applied in the case of recording and displaying a recording image R1 including a plurality of lesion candidate areas almost similarly.

According to the present embodiment, the process for displaying recorded images R1 in the display area D2 in order opposite to order of recording by the recording portion 36b is performed by the display controlling portion 36, but the process is not limited to this. For example, a process for displaying recorded images R1 in the display area D2 in the same order as order of recording by the recording portion 36b may be performed by the display controlling portion 36.

According to the present embodiment, the process for causing recorded images R1 of respective frames recorded during the period of measurement of the continuous detection time period TL to be sequentially displayed in the display area D2 is performed by the display controlling portion 36, but the process is not limited to this. A process for causing recorded images R1 of a part of frames among the recorded images R1 of the respective frames to be displayed in the display area D2 may be performed by the display controlling portion 36. More specifically, for example, a process for causing only a recorded image R1 corresponding to one frame recorded last among the recorded images R1 of the respective frames recorded during the period of measurement of the continuous detection time period TL to be displayed in the display area D2 may be performed by the display controlling portion 36. Or, for example, a process for, while decimating the plurality of recorded images R1 recorded during the period of measurement of the continuous detection time period TL at predetermined intervals, causing the recorded images R1 to be displayed in the display area D2 may be performed by the display controlling portion 36.

According to the present embodiment, for example, the recording portion 36b may record respective observation images G1 obtained by decimating a plurality of observation images G1 sequentially outputted from the video processor 31 during the period of measurement of the continuous detection time period TL at predetermined intervals, as recorded images R1.

According to the present embodiment, the recording portion 36b is not limited to such a configuration that sequentially records observation images G1 of a plurality of frames as recorded images R1 but may, for example, record only an observation image of one frame as a recorded image R1. More specifically, the recording portion 36b may, for example, record only an observation image G1 inputted to the display controlling portion 36 at a timing immediately before measurement of the continuous detection time period TL is stopped (the observation images G1 shown in FIGS. 6 and 10) as a recorded image R1.

According to the present embodiment, when the display controlling portion 36 causes a recorded image R1 of each frame recorded in the recording portion 36b to be displayed in the display area D2, the display controlling portion 36 may cause the recorded image R1 to be equal-speed displayed at the same frame rate as a frame rate at the time of recording by the recording portion 36b, may cause the recorded image R1 to be double-speed displayed at a frame rate higher than the frame rate at the time of recording by the recording portion 36b, or may cause the recorded image R1 to be slow-displayed at a frame rate lower than the frame rate at the time of recording by the recording portion 36b.

According to the present embodiment, when the display controlling portion 36 causes the recorded image R1 recorded in the recording portion 36b to be displayed in the display area D2, the display controlling portion 36 may cause the recorded image R1 to be displayed in the same color as color at the time of recording by the recording portion 36b, may cause the recorded image R1 to be displayed in subtractive color obtained from the color at the time of recording by the recording portion 36b, or may cause the recorded image R1 to be displayed only in predetermined one color.

According to the present embodiment, for example, recording of recorded images R1 may be started at a desired timing before the timing when detection of the lesion candidate area L1 is started as long as recording of recorded images R1 is performed during the period of measurement of the continuous detection time period TL.

According to the present embodiment, when the display controlling portion 36 causes a recorded image R1 recorded in the recording portion 36b to be displayed in the display area D2, an enhancement process for generating a marker image G2 based on lesion candidate information IL recorded in a state of being associated with the recorded image R1 and adding the generated marker image G2 to the recorded image R1 may be performed by the enhancement processing portion 36a. According to such an operation of the display controlling portion 36, for example, it is possible to, at the timing of the time Tc in FIG. 3 or at the timing of the time Tf in FIG. 8, cause a display image on which a position of the lesion candidate area L1 included in the recorded image R1 in the display area D2 is enhanced as shown in FIG. 12 to be displayed on the display screen 41A. FIG. 12 is a diagram showing an example of a display image displayed on the display apparatus after a process of the image processing apparatus according to the embodiment is performed.

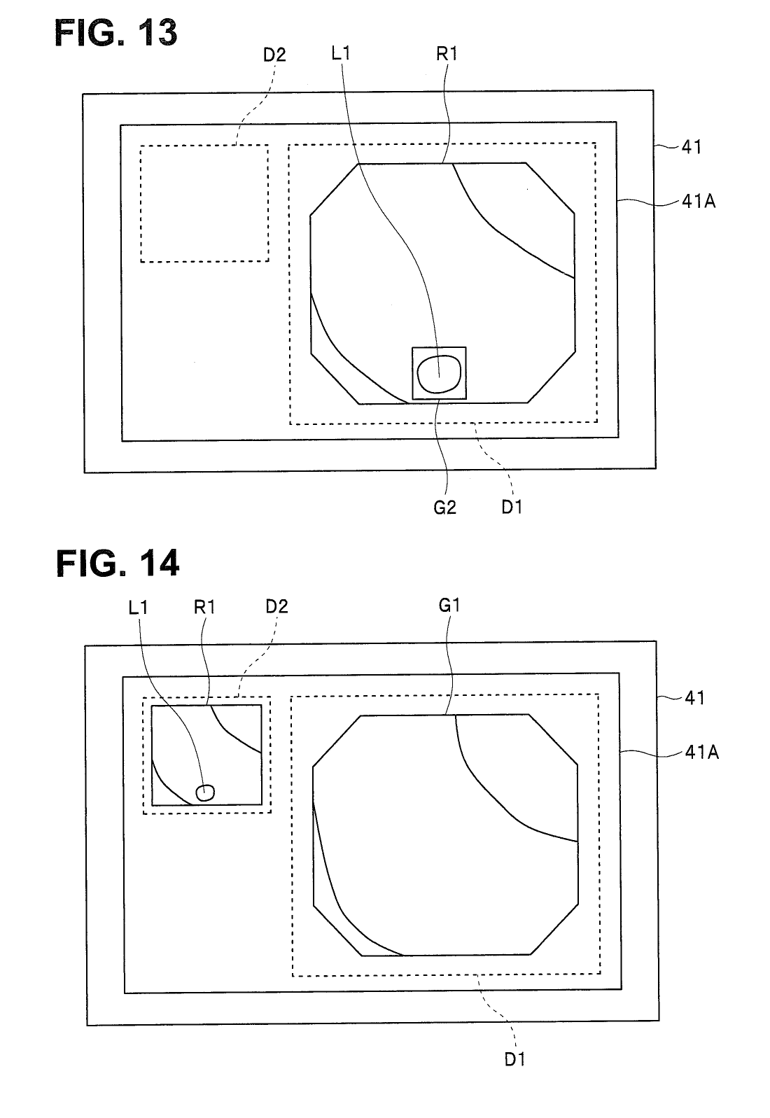

According to the present embodiment, a process for causing a display image on which a recorded image R1 recorded in the recording portion 36b is disposed in the display area D1 to be temporarily displayed instead of an observation image G1, and causing each of such recorded images R1 displayed in the display area D1 instead of an observation image G1 to be sequentially redisplayed in the display area D2 may be performed by the display controlling portion 36. According to such an operation of the display controlling portion 36, for example, it is possible to, at the timing of the time Tc in FIG. 3 or at the timing of the time Tf in FIG. 8, cause a display image on which a position of the lesion candidate area L1 included in the recorded image R1 in the display area D1 is enhanced as shown in FIG. 13 to be displayed on the display screen 41A. According to the operation of the display controlling portion 36 as described above, for example, it is possible to cause a display image as shown in FIG. 14 to be displayed on the display screen 41A after display of each recorded image R1 in the display area D1 is completed. FIGS. 13 and 14 are diagrams showing examples of a display image displayed on the display apparatus after a process of the image processing apparatus according to the embodiment is performed.

According to the present embodiment, for example, if the display area D2 is not set on the display screen 41A, a process for causing a recording image R1 and/or a marker image G2 to be displayed in the display area D1 may be performed by the display controlling portion 36.

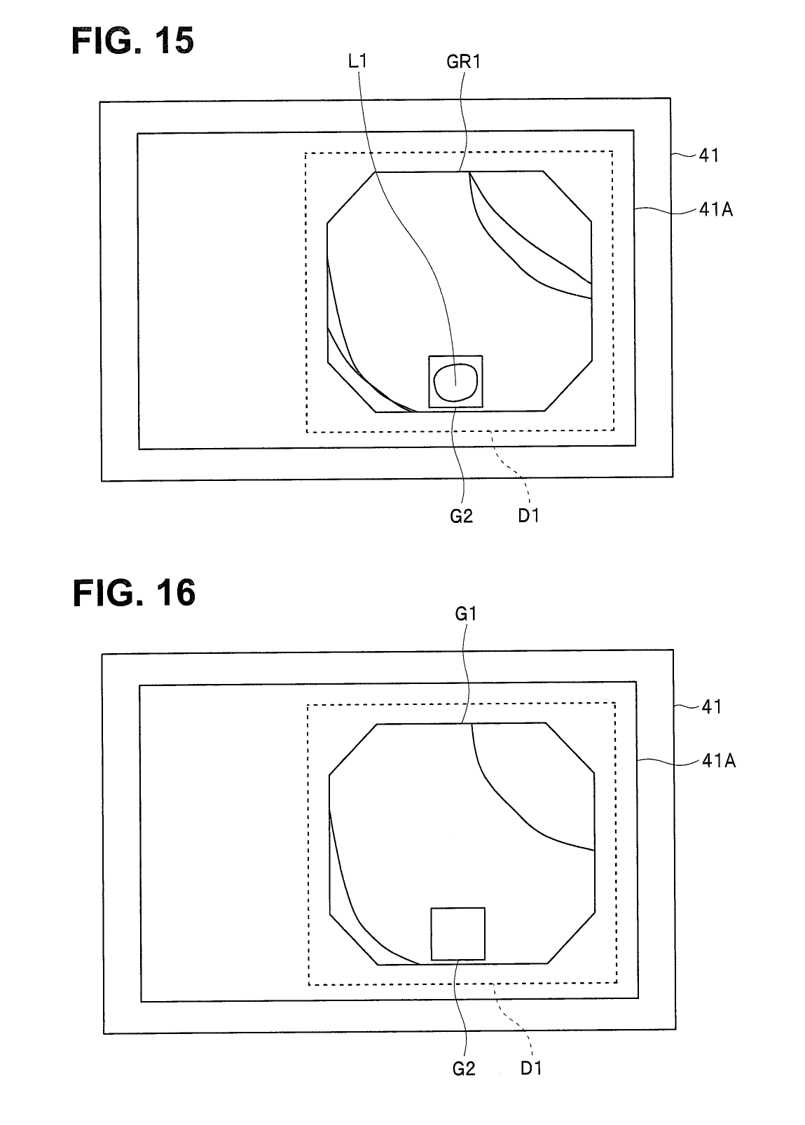

More specifically, for example, a process for generating a composite image GR1 by combining an observation image G1 sequentially outputted from the video processor 31 and a recorded image R1 recorded in the recording portion 36b, generating a marker image G2 based on lesion candidate information IL associated with the recorded image R1, and adding the marker image G2 to the composite image GR1 to cause the marker image G2 and the composite image GR1 to be displayed in the display area D1 may be performed by the display controlling portion 36. According to such an operation of the display controlling portion 36, for example, it is possible to, at the timing of the time Tc in FIG. 3 or at the timing of the time Tf in FIG. 8, cause a display image on which a position of the lesion candidate area L1 included in the composite image GR1 in the display area D1 is enhanced as shown in FIG. 15 to be displayed on the display screen 41A. FIG. 15 is a diagram showing an example of a display image displayed on the display apparatus after a process of the image processing apparatus according to the embodiment is performed.

Otherwise, for example, a process for generating a marker image G2 based on lesion candidate information IL recorded in the recording portion 36b, and adding the generated marker image G2 to an observation image G1 sequentially outputted from the video processor 31 to cause the marker image G2 and the observation image G1 to be displayed in the display area D1 may be performed by the display controlling portion 36. According to such an operation of the display controlling portion 36, for example, it is possible to cause a display image as shown in FIG. 16 to be displayed on the display screen 41A of the display apparatus 41 at the timing of the time Tc in FIG. 3 or at the timing of the time Tf in FIG. 8. FIG. 16 is a diagram showing an example of a display image displayed on the display apparatus after a process of the image processing apparatus according to the embodiment is performed.

The image processing apparatus and the like according to the present embodiment may include a processor and a storage (e.g., a memory). The functions of individual units in the processor may be implemented by respective pieces of hardware or may be implemented by an integrated piece of hardware, for example. The processor may include hardware, and the hardware may include at least one of a circuit for processing digital signals and a circuit for processing analog signals, for example. The processor may include one or a plurality of circuit devices (e.g., an IC) or one or a plurality of circuit elements (e.g., a resistor, a capacitor) on a circuit board, for example. The processor may be a CPU (Central Processing Unit), for example, but this should not be construed in a limiting sense, and various types of processors including a GPU (Graphics Processing Unit) and a DSP (Digital Signal Processor) may be used. The processor may be a hardware circuit with an ASIC or an FPGA. The processor may include an amplification circuit, a filter circuit, or the like for processing analog signals. The memory may be a semiconductor memory such as an SRAM and a DRAM; a register; a magnetic storage device such as a hard disk device; and an optical storage device such as an optical disk device. The memory stores computer-readable instructions, for example. When the instructions are executed by the processor, the functions of each unit of the image processing device and the like are implemented. The instructions may be a set of instructions constituting a program or an instruction for causing an operation on the hardware circuit of the processor.

The units in the image processing apparatus and the like and the display device according to the present embodiment may be connected with each other via any types of digital data communication such as a communication network or via communication media. The communication network may include a LAN (Local Area Network), a WAN (Wide Area Network), and computers and networks which form the internee, for example.

What is claimed is:

1. An image processing apparatus comprising a processor, the processor being configured to:
perform a process for detecting an area of interest for each of a plurality of observation images that are sequentially inputted;
record the plurality of observation images as one or more recorded images during a time period until detection of the area of interest is interrupted/ceased after the detection is started; and
perform a process for, while causing the plurality of observation images to be sequentially displayed on a display screen of a display apparatus, causing at least one recorded image among the one or more recorded images to be displayed on the display screen at a first timing when a predetermined time period elapses after the detection of the area of interest is started or at a second timing when the detection of the area of interest is interrupted/ceased.

2. The image processing apparatus according to claim 1, wherein, if the time period until the detection of the area of interest is interrupted/ceased after the detection is started is shorter than the predetermined time period, the processor performs the process for, while causing the plurality of observation images to be sequentially displayed on the display screen, causing the at least one recorded image among the one or more recorded images to be displayed on the display screen at the first timing.

3. The image processing apparatus according to claim 1, wherein, if the time period until the detection of the area of interest is interrupted/ceased after the detection is started is equal to or longer than the predetermined time period, the processor performs the process for, while causing the plurality of observation images to be sequentially displayed on the display screen, causing the at least one recorded image among the one or more recorded images to be displayed on the display screen at the second timing.

4. The image processing apparatus according to claim 1, wherein
the processor mutually associates and records position information showing a position of the area of interest and the one or more recorded images during the time period; and
the processor performs an enhancement process for enhancing the position of the area of interest included in the at least one recorded image caused to be displayed on the display screen, based on the position information, either at the first timing or at the second timing.

5. The image processing apparatus according to claim 1, wherein the processor performs a process for, while causing the plurality of observation images to be sequentially displayed in a first display area on the display screen, causing the at least one recorded image among the one or more recorded images to be displayed in a second display area on the display screen.

6. The image processing apparatus according to claim 5, wherein the second display area is set as an area having a smaller size than the first display area on the display screen.

7. The image processing apparatus according to claim 1, wherein the processor performs a process for causing the one or more recorded images to be sequentially displayed on the display screen in order opposite to order of recording the one or more recorded images.

8. The image processing apparatus according to claim 1, wherein the processor performs a process for causing a recorded image recorded last, among the one or more recorded images, to be displayed on the display screen.

9. The image processing apparatus according to claim 1, wherein the processor performs a process for causing the one or more recorded images to be displayed on the display screen while decimating the one or more recorded images at predetermined intervals.

10. The image processing apparatus according to claim 1, wherein the processor records each of observation images obtained by decimating the plurality of observation images at predetermined intervals as a recorded image during the time period.

11. An image processing method comprising:
performing a process for detecting an area of interest for each of a plurality of observation images obtained by performing image pickup of an object;
recording the plurality of observation images as one or more recorded images during a time period until detection of the area of interest is interrupted/ceased after the detection is started; and
performing a process for, while causing the plurality of observation images to be sequentially displayed on a display screen of a display apparatus, causing at least one recorded image among the one or more recorded images to be displayed on the display screen at a first timing when a predetermined time period elapses after the detection of the area of interest is started or at a second timing when the detection of the area of interest is interrupted/ceased.

12. The image processing method according to claim 11, wherein, if a time period until the detection of the area of interest is interrupted/ceased after the detection is started is shorter than the predetermined time period, the process for, while causing the plurality of observation images to be sequentially displayed on the display screen, causing the at least one recorded image among the one or more recorded images to be displayed on the display screen is performed at the first timing.

13. The image processing method according to claim 11, wherein, if the time period until the detection of the area of interest is interrupted/ceased after the detection is started is equal to or longer than the predetermined time period, the process for, while causing the plurality of observation images to be sequentially displayed on the display screen, causing the at least one recorded image among the one or more recorded images to be displayed on the display screen is performed at the second timing.

14. The image processing method according to claim 11, wherein
position information showing a position of the area of interest and the one or more recorded images are mutually associated and recorded during the time period; and
an enhancement process for enhancing the position of the area of interest included in the at least one recorded image caused to be displayed on the display screen, based on the position information is performed either at the first timing or at the second timing.

15. The image processing method according to claim 11, wherein a process for, while causing the plurality of observation images to be sequentially displayed in a first display area on the display screen, causing the at least one recorded image among the one or more recorded images to be displayed in a second display area on the display screen is performed.

16. The image processing method according to claim 15, wherein the second display area is set as an area having a smaller size than the first display area on the display screen.

17. The image processing method according to claim 11, wherein a process for causing the one or more recorded images to be sequentially displayed on the display screen in order opposite to order of recording of the one or more recorded images is performed.

18. The image processing method according to claim 11, wherein a process for causing a recorded image recorded last among the one or more recorded images to be displayed on the display screen is performed.

19. The image processing method according to claim 11, wherein a process for causing the one or more recorded images to be displayed on the display screen while decimating the one or more recorded images at predetermined intervals is performed.

20. The image processing method according to claim 11, wherein each of observation images obtained by decimating the plurality of observation images at predetermined intervals is recorded as a recorded image during the time period.
